(19) United States
(12) Patent Application Publication
(10) Pub. No.: US 2002/0038925 A1
(43) Pub. Date: Apr. 4, 2002

(54) Apparatus and method for continuous surface modification of substrates

(76) Inventor: Karl Reimer, Suisun City, CA (US)

Correspondence Address: Rajiv Yadav, McCutchen, Doyle, Brown & Enersen, LLP, Three Embarcadero Center, 28th Floor, San Francisco, CA, 94111, US

(21) Appl. No.: 09/836,452

(22) Filed: Apr. 16, 2001

Related U.S. Application Data
(60) Provisional application No. 60/197,836, filed on Apr. 14, 2000.

(51) Int. Cl. B29C 71/02; B29C 71/04

(52) U.S. Cl. 264/448; 264/492; 425/73; 425/174.4

(57) ABSTRACT

In accordance with the present invention, an apparatus and method are provided for preparing a substrate for adhering a material onto the surface of the substrate. The surface of the substrate to be prepared is exposed to electromagnetic radiation comprising ultra-violet radiation, whereby the substrate surface is decontaminated and/or modified by exposure to the ultra-violet radiation. Also disclosed is the use of an electro-ionization device, such as a Corona discharge device, and/or an infra-red radiation source in conjunction with electromagnetic radiation to modify the surface of the substrate to be prepared. Additionally, the use of gaseous components to modify the chemical functionalities on the substrate's surface is described. The invention has diverse applications, including, shoe fabrication, aircraft and space vehicle manufacture, automobile manufacturing and deposition of biochemical samples onto microarray well-plates.

### RELATED APPLICATION DATA

This application claims priority to U.S. provisional application Ser. No. 60/197,836, filed Apr. 14, 2000, the entire disclosure of which is incorporated herein by reference.

### FIELD OF THE INVENTION

This invention relates to an apparatus and method for continuous surface modification of polymeric materials, that utilize electromagnetic energy or a combination of electromagnetic energy and electro-ionization to effect surface treatment for adhesion enhancement and other advantageous purposes.

### BACKGROUND OF THE INVENTION

Generally, for materials to bond or adhere to a substrate certain criteria must be met. For example, the substrate must be clean of materials which are not firmly attached to it, such as oils, low molecular weight polymers and other types of materials that act as surface contaminants. Further, the substrate surface must have the appropriate chemistry to provide good close contact (substrate wettability) and induce adhesion with the material being bonded.

Thus, while in some cases, a glue or adhesive will adhere effectively to a substrate with no additional surface preparation (cleaning, roughening or other type of surface modification), in general, the surface of a substrate must be prepared for effective adhesion. However, the existing techniques, methods and procedures used to prepare substrate surfaces for effective adhesion of materials suffer from a number of drawbacks.

One method of surface preparation is mechanical roughening of the surface. For example, in footwear manufacturing, elastomeric shoe parts are either mechanically roughened and/or chemically modified to enhance adhesion between the adhesive and the shoe parts (e.g. bonding of the mid-sole and the outer sole). However, mechanical roughening entails a number of time-consuming steps. Further, mechanical treatments such as roughening or abrading substrate surfaces are labor-intensive and subject to human error. Also, in some cases mechanical roughening is unacceptable because of damage to the material properties such as in high performance satellite structures or in some types of shoe mid-soles.

Another common surface preparation method relies on the use of toxic treatment chemicals ranging from cleaning solutions comprising acetone or chlorinated solvents to sodium hydroxide etching solutions to aggressive chlorinating agents. For example Pearson et. al. (U.S. Pat. No. 4,158,378) relates to the use of chlorine water treatment on cured polyurethane and rubber surfaces. Another example is U.S. Pat. No. 4,500,685, which relates to modifying rubber surfaces with the use of various halogenating agents including halogenated isocyanuric acids. This approach is currently the industry standard for preparing surfaces of shoe parts (mid-soles, outer-soles etc.) for shoe fabrication. Because chemical treatment processes require the use of toxic and hazardous chemicals, they pose a danger to humans and the environment.

Processes such as continuous incoherent irradiation of UV light alone or with oxygen or ozone have also been used to prepare surfaces of certain substrates or etching of organic materials. The use of UV to activate a gas for etching semiconductor materials was presented by Hall in 1958 (U.S. Pat. No. 2,841,471). However, the disclosed process requires long continuous exposure times of at least 2 to 5 minutes, and does not teach use of the process in adhesive applications. U.S. Pat. No. 4,028,135 shows that precleaning quartz resonator surfaces with solvents followed by exposure to UV light resulted in acceptably clean parts in as short as 20 seconds of UV light exposure and in the presence of oxygen. However, the process includes a precleaning step using solvents such as trichlorotrifluaroethane and ethyl alcohol, which are a health and environmental hazard and present serious waste disposal problems. Zeley (U.S. Pat. No. 5,098,618) describes the use of UV for cleaning plastic parts to improve wettability but, again, the disclosed process requires precleaning with solvents such as ethyl alcohol. Also, the process requires a chamber to be filled with oxygen during UV exposure and exposure times exceeding 5 minutes for successful treatment.

Most recently, Basil et. al. (U.S. Pat. No. 6,042,737) disclose using UV to improve adhesion of polymeric coatings to organic substrates prepared from or coated with monomers composed of acrylic functionalities. However, their process requires the substrates to be chemically etched with sodium hydroxide solution, following the UV-oxygen or ozone exposure, before applying the coating in order to obtain acceptable adhesion of film coatings. In addition, because their process requires an additional step using a toxic chemical etch solution, it would require two additional steps of rinsing and drying in order to be useful in any final application such as for coatings and the like. Because of the number of steps, toxic chemicals involved and the time to perform each step, this process would not be useful in an industrial manufacturing environment such as fabrication of shoes.

Laser ablation and cleaning techniques have been reported (for example, U.S. Pat. Nos. 4,803,021 and 5,669,979) to clean substrates including semiconductor materials, surgical equipment etc. However, effective irradiation of large, complex substrate surface topographies and/or shapes that have non-uniformity in order to achieve full and complete uniform coverage, on a continuous basis, and using the small precision beam of a laser is very difficult at best. These approaches would require sophisticated expensive scanning and rastering equipment. Also, there would be problems controlling uniform energy exposure across surfaces, which may lead to inadvertent overheating or thermal decomposition of the substrate surface. Additionally, the operation would have to include another step to provide appropriate surface chemistry changes to provide effective adhesion to the coatings being applied.

Similarly, the use of pulsed optical energy to increase the bondability of a surface as disclosed in U.S. Pat. No. 5,512,123, suffers from the problems of non-uniform coverage and overlapping exposures that can result in unacceptably severe thermal overheating and photodecomposition at the surface.

Corona discharge and atmospheric plasma methods have been shown to be effective for cleaning and modifying polymeric materials for subsequent bonding operations. Such processes are described for example in U.S. Pat. Nos. 5,332,897, 5,972,176, 5,069,927, 5,928,527 and 5,185,132. However, these methods suffer at least one or more unacceptable drawbacks such as requiring extremely close proximity and tight tolerances of the electrode to the surface being treated, being able to treat only very small areas at one time, requiring the use of expensive inert gases, being confined to the use of enclosed chambers, being able to treat thin films only, or requiring additional secondary operations such as toxic chlorination treatments and in some cases, depend on the dielectric of the material being treated.

Vacuum plasma methods have also been shown to be an effective way to clean and chemically modify the surfaces of a number of polymeric substrates as in, for example, U.S. Pat. No. 5,236,512 and PCT patent application publication WO/001528. However, such methods are not suitable for use in most applications such as the manufacturing of shoes, because they utilize batch processing and are restricted in the number of substrates that can be treated at one time. Furthermore, it requires significant time to cycle from atmospheric pressure to operating vacuum pressures and subsequently vent to ambient pressure again, has relatively long process times of typically >10 minutes, is unable to effectively treat materials that contain volatile materials such as processing aids, oils etc. that are very common in elastomeric materials and has high capital equipment costs and requires maintenance of pumps and other equipment. In addition, large objects cannot effectively be processed due to size limitations of the chamber.

Each of the surface preparation methods described above thus has one or more noteworthy drawbacks. For example, most commercially available primers are chlorinated and are toxic. Additionally, they utilize organic solvents that are not environmentally friendly. Further, these primers are usually applied individually to the substrates by hand and the processes are thus very labor intensive and subject to human error. Other processes such as vacuum plasma treatment or corona discharge are at most minimally effective in chemically modifying plastics or elastomers and/or can only be used in a slow batch process or require a substantial amount of expensive equipment which, in turn, requires expensive on-going maintenance.

Furthermore, several of the above-mentioned surface preparation methods are very labor intensive and/or limited to a relatively slow batch process. In general, they cannot provide the necessary performance or quality, and/or cannot be effectively used on large or non-uniform shaped substrates, and/or utilize toxic chemicals and/or expensive equipment.

Therefore, a need exists for an environmentally friendly, non-labor intensive, cost effective, processing method, which can be operated in a continuous mode to modify surfaces of materials (both manmade and naturally occurring polymeric materials) for adhesion enhancement and which can be used in an environment such as (but not limited to) a production assembly line.

### SUMMARY OF THE INVENTION

The present invention satisfies the aforementioned needs and other by providing equipment and methods for continuous modification processing of substrates for adhering materials such as adhesives and other polymers and compounds that utilize electromagnetic energy or a combination of electromagnetic energy and electro-ionization to effect surface treatment for adhesion enhancement.

In one embodiment the invention is an apparatus for preparing a substrate, which comprises an electromagnetic (EM) radiation source for generating an active zone, wherein the electromagnetic radiation comprises radiation in the far ultra-violet region and wherein the electromagnetic radiation is directed to impinge on the substrate exposing a surface of the substrate to the active zone whereby the substrate is modified for adhering a material onto the surface of the substrate by exposure to the active zone. The apparatus of the invention operates at substantially ambient pressure.

The invention also provides methods for preparing a substrate for adhering materials such as glue onto the surface of the substrate. Thus, in one embodiment, the invention provides a method for preparing a polymer substrate, which comprises generating an active zone using an electromagnetic radiation source, and exposing said polymer substrate to the active zone whereby the polymer substrate is modified for adhering a material comprising an adhesive onto the polymer substrate by exposure to said active zone, and wherein the method is performed at substantially ambient pressure. The substrates that can be prepared using the apparatus or the methods of the invention, include, but are not limited to, a sole of a shoe, a composite component used in aircraft or space vehicle manufacture, composite and plastic components used in automobile manufacture and substrates used in biochemical analysis, for example, plastic well-plates.

As described more fully below, the substrate to be treated is preferably a polymeric substrate. Thus, the apparatus of the invention can be used to treat substrates comprised of a synthetic polymer or substrates comprised of a naturally-occurring polymer. The apparatus of the invention is used to adhere various materials to the substrate, for example, an adhesive material. In a preferred embodiment, the apparatus of the invention is used to glue a surface of one substrate to a surface of another substrate.

In one embodiment, the apparatus of the invention further comprises an electro-ionization device, which preferably is located in the active zone although embodiments in which the electro-ionization device is not located in the active zone are also contemplated for the invention. The apparatus of the invention may further comprise a gas supply system for circulating a gas past the electro-ionization device.

In another embodiment, the apparatus of the invention further comprises an infra-red radiation source for heating the substrate by exposure to the infra-red radiation. Preferably, the infra-red radiation source is located to heat the substrate prior to exposure of the substrate to the electromagnetic radiation source.

Also contemplated in the scope of the invention is injection of gases over the substrate being prepared, which gases impart a desired chemical functionality to the surface of the substrate. Thus, the invention provides for gas injectors for injecting a gas over the surface of the substrate exposed to the active zone. Preferably, the gas to be injected over the surface of the substrate exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen. However, depending on the functionalities desired on the surface of the substrate, other inorganic or organic gases may be used.

In one embodiment, the invention is directed to a method for cleaning and/or imparting chemical changes on the substrate surface that affects the adherence of compounds ranging from atoms, simple molecules to macro molecules. The surface of a polymeric material such as a plastic is cleaned and/or chemically modified in a continuous fashion using the process of this invention. The modified plastic substrate is then coated with the materials to be adhered, including but not limited to such compounds as isocyanates, anhydrides, carbodiimides, oxiranes, thiiranes, or epoxies, or bio-organic compounds such as DNA, etc. for changing or controlling wettability or providing bio-compatibility of a substrate.

In another embodiment, the invention is directed to a method for enhancing the adhesion characteristics of substrates for glues, adhesives, paints, specialty coatings, and other resinous materials.

One aspect or advantage of the invention involves the removal of contaminants on the substrate to be bonded to by way of a continuous electromagnetic exposure treatment at atmospheric pressure. This continuous surface treatment process of the invention provides sufficiently intense electromagnetic radiation to vaporize and eliminate contaminants such as moisture, oils, low molecular weight polymers and other potentially volatile contaminant compounds or oxidized by-products of such from the substrate surface. This step of the process occurs rapidly in order to affect only the uppermost portion of the surface. Because of this, the process can be used to treat substrates such as those used in shoe manufacturing without necessitating pre-cleaning with hazardous or toxic solvents or the like. This feature also prevents potential physicochemical damage that may occur to the bulk polymer. For example, when cleaning an elastomeric foam material, such as EVA (ethylene vinyl acetate), which is commonly used in the footwear industry as a mid-sole material, prolonged exposure to any significant energy such as heat could cause irreversible dimensional changes that would render the shoe part unusable. However, in some extreme cases where the contaminant coating is pervasive or tenaciously bound, some type of pre-cleaning may be necessary.

The invention is also directed towards modifying the chemistry of a surface that is composed of at least one or more functional groups, including but not limited to functional groups containing at least one or more oxygen, nitrogen or chlorine atoms chemically bonded to the substrate surface. The resultant chemically modified surface of the substrate then contains the desired functionalities such as amine, chlorine, hydroxyl, carbonyl or carboxyl groups etc. that will facilitate good close contact (wettability) between the material being adhered and the substrate and allow effective adhesion of the substrate to the desired material, such as a coating, adhesive or resinous compound.

In another embodiment, the invention is directed to a method and apparatus for fabricating a shoe having at least one sole. The surface of at least one side of the sole (for instance, an outsole) is chemically modified using the inventive continuous process. The modified outsole surface is either adhesively bonded to the upper construction of the shoe or to another shoe part such as a mid-sole. Preferably the material that is bonded to the treated outsole surface (or other treated surface) in this step has also been treated for surface modification using the process of this invention. However, it is not necessary that this latter material shall have been treated using the inventive process; some untreated materials can be bonded to the treated outsole. This continuous conveyor-based process allows the shoe part surfaces to be cleaned, modified for bonding without the use of toxic solvents or chemicals and bonded directly after surface modification.

### BRIEF DESCRIPTION OF THE DRAWINGS

FIG. 1 is a general schematic showing the components of one embodiment of the invention.

FIG. 2 is a schematic depiction of an embodiment of the invention using continuous processing equipment.

FIG. 3 is an embodiment with an electro-ionization device and a gas injection system.

FIG. 4 is a schematic depiction of an embodiment with continuous processing equipment with exhaust and ventilation systems.

FIG. 5 is an illustration of an example shoe depicting surfaces and shoe substrates that require surface preparation prior to adhesive application and bonding.

### DETAILED DESCRIPTION OF THE PREFERRED EMBODIMENTS

One route to achieving improved adhesion is to increase the wettability or the continuous close contact between the adhesive and the substrate being adhered to. Wettability is essential for adhesives such as hot melt and contact (pressure sensitive) types of adhesives. It has been found that the process of the invention provides increased wettability of the polymeric surface with various materials such as water, isocyanates, paints, and adhesives including but not limited to epoxies, water-based urethanes and hot melts. Non-reactive adhesive systems or coatings rely mostly on several adhesion mechanisms that include mechanical interlocking, molecular diffusion, and electrostatic interactions such as electrostatic forces, Van der Waals forces, hydrogen bonding, coulombic forces and/or dipole-dipole interactions between the adhesive and a polymer surface. Surfaces that have appropriate chemical functionalization free from inhibiting contaminants typically provide such wettability characteristics.

Another factor that determines adhesion (such as for reactive adhesives and coatings with epoxy and isocyanate cure systems) is the ability of the material being applied to chemically bond to the substrate. In other words, the substrate must have the correct chemistry to chemically react with this material. For, example, for an amine cured epoxy system, the epoxy portion of the system chemically reacts with the amine moiety forming a covalent bond between the carbon (formerly bonded to the epoxide oxygen) and the nitrogen of the amine. The reaction forms a strong three-dimensional molecular structure providing excellent cohesive strength. Thus, if amine functionalities are present on the surface of the substrates to be bonded with an amine cured epoxy, the resulting product of the chemical reaction of the adhesive and substrate will include the amine functionalities on the surface that will be incorporated into the molecular network of the adhesive. This molecular network formation enhances the adhesion between the substrate and the adhesive. The process of the present invention provides a way for enhancing the ability of substrates to adhere to other compositions, such as adhesives and coatings.

The processes of this invention are directed to methods of providing surface modification on surfaces of metallic and non-metallic substrates for adhesion enhancement. These processes involve effecting physicochemical changes on a substrate surface by exposing it to electromagnetic radiation ranging from the far UV to IR. Additionally, the substrate may be optionally exposed to one or more of the following reactive species: ionized gases containing positive and negatively charged particles, free radicals, and electronically excited gas molecules. The invention also provides for an optional electro-ionization treatment of the substrate, which may be an in-situ one, “in-situ” in this context meaning treatment in the pathway of the electromagnetic radiation flux and/or may be introduced following or preceding the EM radiant flux exposure.

The inventive processes effect physicochemical changes on the uppermost surfaces of substrates, which may be metallic or non-metallic substrates, that enhance the adhesion of various materials and will be detailed below. These changes occur on a continuous basis when substrates are passed through the active zone of this invention with constant exposure to the electromagnetic radiation and, in most cases, to the reactive species mentioned above, as described herein.

The electromagnetic radiation source can be any source that provides continuous emissions in the wavelengths and levels as set forth below. A number of such sources are available in the marketplace, each having advantages and disadvantages. Preferred sources of the invention are UV sources, which are described in S. P. Pappas, UV Curing: Science and Technology, published by Technology Marketing Corporation, 1978, pages 96-132, which is incorporated herein by reference.

The type of bulbs preferred here are electrode or electrode-less high quality quartz (synthetic or non-synthetic) bulbs filled with materials such as, but not limited to, mercury or xenon/mercury. For the electrode-less bulb, the bulb is ignited and a sustained emission of UV radiation is obtained by the use of microwave radiation. In the cases for electrode-less bulbs and equipment, there are several commercial suppliers of these units such as Fusion UV Systems, Inc., Ultraphase Equipment, Inc. and Nordson, UV Systems Division. The equipment and technology of these types of lamp systems are described in U.S. Pat. Nos. 4,718,974, 6,015,503 and 4,885,047, and references therein. Electrode bulb type units are very common in the industry and can be found within references above.

The basic process of the invention which involves the use of continuous or constant exposure, for a defined period of time, of the substrate surface to electromagnetic radiation, primarily in the far-ultraviolet spectrum, optionally used in tandem with a controlled and regulated reactive gas environment on the surface at ambient atmospheric pressure can treat many substrates very effectively. In some cases, however, due to a desire to increase the production (treatment) rate for economic reasons, for the treatment of unusually inert surfaces, or because of a need to increase the rate of incorporating chemical functionalities on the surface for a particular application, there is a need to enhance or significantly raise the treatment intensity at the substrate surface.

This increase in intensity or providing a more aggressive treatment can be brought about by increasing the spectral output or, alternatively, by incorporation of such devices as an electro-ionization device. Thus, if there is a need to have higher concentrations of free radicals and ionized particles to interact with the substrate surface for reasons such as, but not limited to, shortening residence time within the active zone to increase treatment production or to provide higher concentration of functional groups to accommodate different adhesives or to overcome anti-photo-dissociation additives (free radical scavengers) or antioxidants that are sometimes incorporated into polymeric materials, an electro-ionization device can be utilized, which can be used in situ, i.e., in the pathway of the existing continuous electromagnetic radiant flux, or outside the active zone. The electro-ionization process is dependent on the ability of the electromagnetic radiant flux to facilitate its performance.

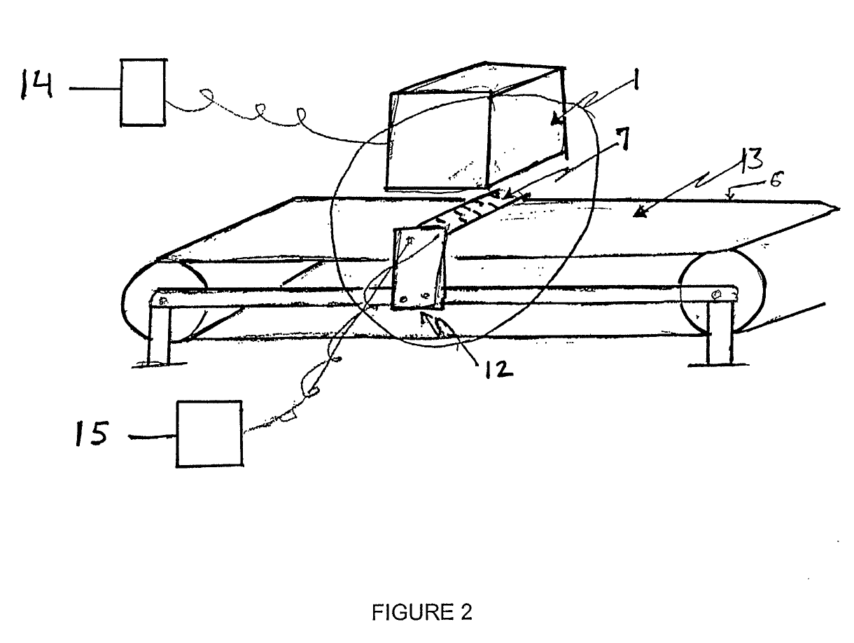

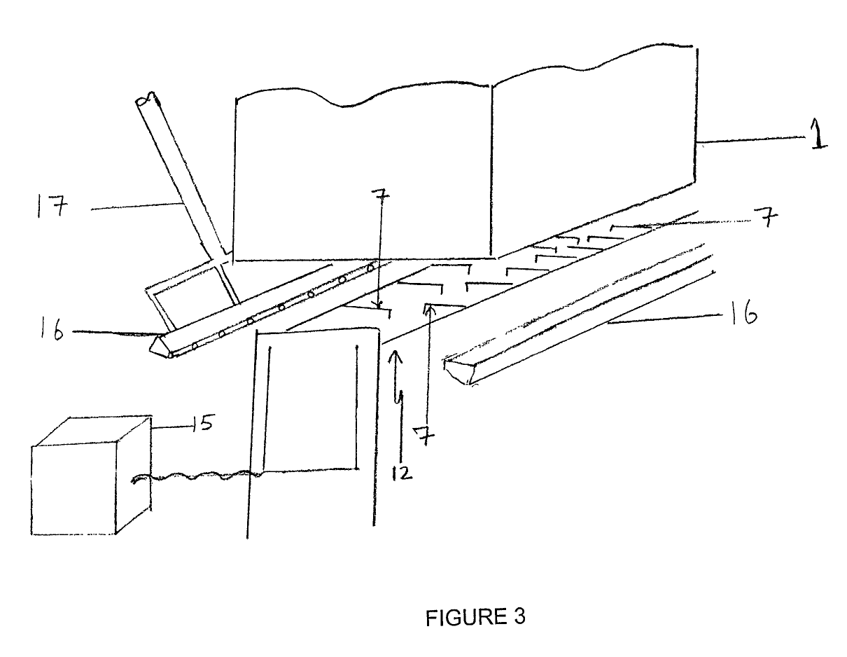

Electro-ionization devices, such as the well-known corona discharge devices or atmospheric plasma devices, are used to generate ions by flowing a gas through a narrow gap bordered by two electrodes. An alternating high voltage is connected across the electrodes, producing a high voltage field across the gap which creates a corona discharge. This discharge, which is also known as a “silent discharge” or “cold plasma discharge”, converts a percentage of the gas to ions and other reactive species. As can be seen by reference to FIGS. 2 and 3, the electro-ionization device of the invention 12 has a plurality of in-line electrodes 7 connected to a high voltage alternating current (AC) power supply 15. The application of AC power to the electrodes allows chemically reactive species to form between the electrodes.

The electro-ionization device of the invention is similar to devices well-known in the art, e.g., corona discharge devices, atmospheric plasma devices, atmospheric glow discharge devices, electric arc devices, etc but, compared to these devices, the electro-ionization device of the invention does not rely on inert gases, generally can be energized with a lower voltage and is positioned at a greater distance from the substrate being treated. As noted above, the device can be placed in the path of the electromagnetic radiation flux or, in some cases, it treats the substrate after the substrate exits the active zone. Also contemplated are embodiments in which electro-ionization devices are placed both in situ and outside the active zone.

The electro-ionization device used in some embodiments of the invention has several features. The electrode design in this invention is constructed to achieve continuous ionization across the width of the radiation source. Any particular design that will fulfill this requirement will perform acceptably. However, if the electrodes of the electro-ionization device are placed in the photo active zone, it preferably should be constructed with a minimal practicable cross sectional area so as to not restrict the radiant flux from the UV source by more than about 10%. The voltage requirement may range from 4 to 40 Kvolts. The frequency range may vary from 60 Hz to 40 KHz.

It is known that it requires less energy to ionize atoms and molecules that are already in an electronically excited state (singlet or triplet) compared to those at the ground state. By using the procedure described herein, the energizing of the electro-ionization device requires less voltage than if it were in a non-photo-excited environment. Since this electro-ionization device is energized in an environment that already contains a number of reactive species (electronically excited atoms and molecules, ionized particles and free radicals) the gases in the active zone have much less of an activation energy barrier or ionization potential to overcome, and ionize or dissociate additional electronically excited atoms and molecules (N.P. Cheremisinoff, ed., Handbook of Polymer Science and Technology, Vol. 3, Chapter 13, Effect of UV Radiation on Polymers).

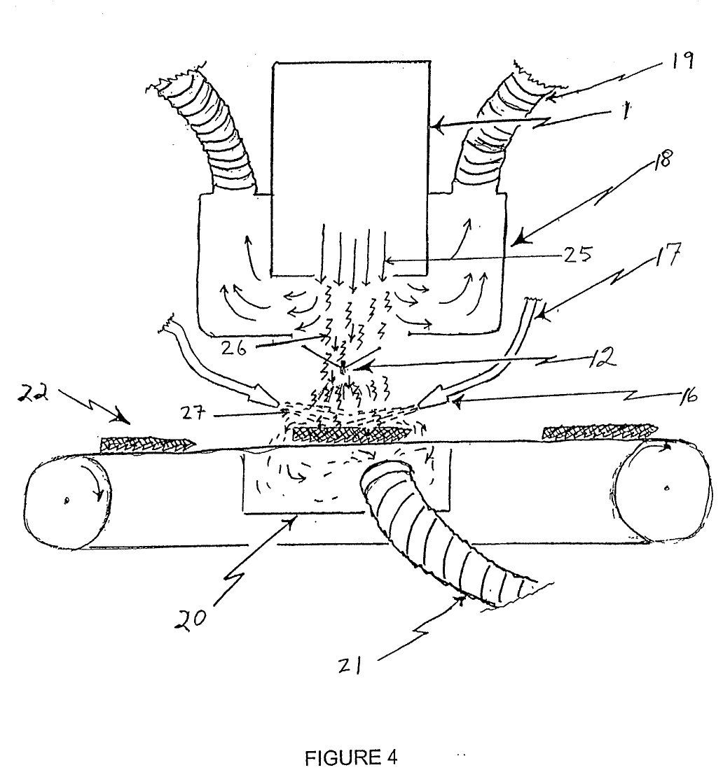

During the process described above the exit gas flow should be maintained such that it allows gases including residual reactive atmosphere species, surface reactive by-products such as carbon dioxide, water, etc. and volatilized contaminants to be removed without inhibiting the inward flow of the processing gas from the inlet jets. FIG. 4 provides further details of this part of the process system.

Also, if desired, the electrode of the electro-ionization device can include magnetic confinement to assist in focusing or confining the charged particles. Examples of such uses are described in U.S. Pat. Nos. 5,433,786 and 5,160,396, the disclosures of which are hereby incorporated herein by reference.

Another feature that may be incorporated in the invention to increase the treatment rate is to expose the substrate surface to infra red (IR) radiation to heat the upper most surface of the substrate in conjunction with the above UV or UV and electro-ionization exposure. This exposure may be imparted prior to or during the UV treatments. Thus, one can choose a source of UV radiation that also emits IR radiation or alternatively use a separate source of IR radiation. The amount of IR radiation may be regulated or limited so that only the uppermost surface of the substrate is exposed to and affected by the heat while the substrate bulk is not affected. This can be accomplished in several ways, for instance, by providing coolant attachments to the reflector that is typically a part of the UV radiation source, or by applying a dichoric reflector coating on the surface of this reflector. Such attachments or coatings are commercially available and/or well known to those skilled in the art.

The process of moving a substrate through the active zone can be accomplished in several ways. One approach particularly suitable for treating larger substrates, such as a composite aircraft wing, involves fixing the processing unit of the invention to a robotic five-axis end effecter that moves the processing unit across the substrate at a predetermined distance and rate from the unit to the surface to be treated. In this approach, the processing equipment rather than the substrate is transported or moved.

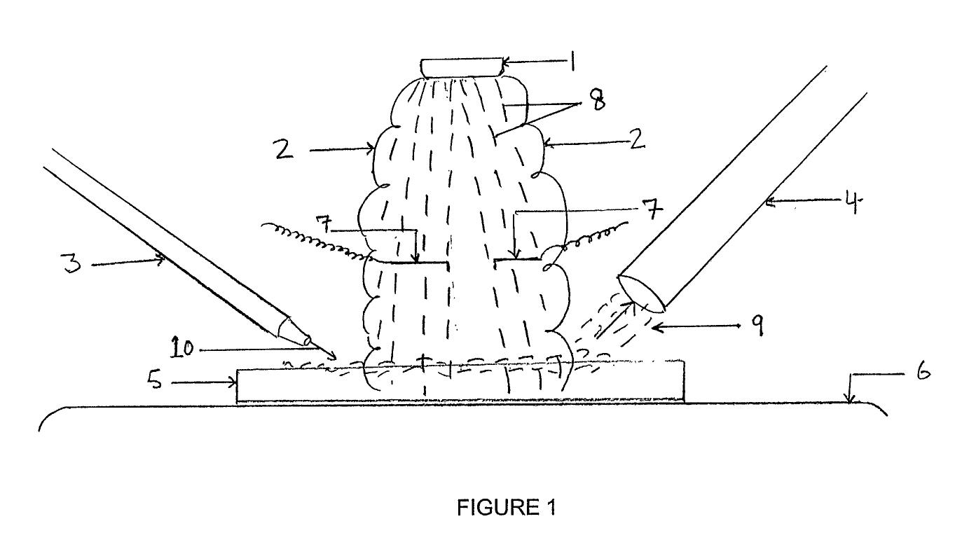

Another approach is to provide a conveyor system to transport smaller parts, such as shoe soles, through the active zone. In this approach the substrate is transported or moved and the processing equipment may be stationary. Such a conveyor system approach is shown in FIGS. 1 through 4. However, the invention is not limited to these specific approaches. Any suitable means for providing a substrate with the requisite electromagnetic exposure will serve the purpose.

The equipment utilized in exemplary embodiments is shown in FIGS. 1 to 4 and comprises one or more of the following: an electromagnetic radiation source that preferably emits radiation comprising the ultraviolet spectrum, gas inlet jets, an exit-gas flow exhaust system, a substrate transport system (for instance, a conveyor system), an infra-red source and an electro-ionization device.

FIG. 1 is a schematic showing the principal and functional components of one embodiment. In FIG. 1, an intense electromagnetic (EM) radiation (ranging from far UV to and optionally including infrared (IR) spectrum) is emitted from a source 1. The EM activates the surface of the substrate 5, whereby the surface is modified and/or contaminants 9 are removed from the surface. The IR radiation, if present, provides direct heat to the surface of the substrate 5 that facilitates contaminant volatilization. Volatilized contaminants and other such materials 9 are removed through a ventilation system 4.

The UV radiant flux, shown by dashes 8, is partially absorbed by the atmosphere within the active zone, which is shown as the clouded area 2. The term “active zone” refers to a zone defined by the radiation flux, at each point within which a measurable amount of electromagnetic radiation falls. The substrate 5 is placed on the conveyor belt 6 of a conveyor system (not shown), allowing it to travel through the active zone 2. Also shown in FIG. 1 are the electrodes 7 of an electro-ionization device, which in the embodiment shown is in situ, i.e., the electrodes are located in the active zone. The gas in the active zone 2 is normally ambient air; however, the composition of this gas atmosphere can be altered for specific types of surface modifications by injecting the active zone with a different gas or gas mixture 10 via inlet jet(s) 3. Preferably, the equipment includes at least two inlet jets in line with the direction of movement of the substrate on the conveyor belt 6 to allow optimum purging of the active zone 2.

The composition of the active zone atmosphere, as discussed below, may include a number of different gases depending on the type of substrate and subsequent surface chemistry needed or may be an inert gas, as discussed below. As a part of the active zone, atmosphere gas molecules will absorb some of the UV radiation and form a number of reactive species including electronically excited atoms and molecules, ionized particles, and free radicals via processes commonly known in the art as photo-absorption, photo-ionization and photo-dissociation. The residual UV radiation will irradiate the substrate surface generating, surface free radicals and electronically excited polymer moieties (parts or specific units of a molecule or polymer) through photo-dissociation of carbon-hydrogen bonds, carbon-carbon bonds and the like. If there are any residual contaminants that did not volatilize from the IR exposure, photo-dissociation of these compounds will facilitate their volatilization and removal from the substrate surface.

With the active zone atmosphere (also referred to as the photon-active zone atmosphere) being in a substantially chemically active state and the substrate being photo-activated, very aggressive chemical changes can occur on the substrate surface, providing the desired optimum chemical functionalities on the surface for subsequent wetting and adhesion to materials such as adhesives. The active zone 2 is not physically confined and is at ambient atmospheric pressure at all times.

FIG. 2 is a schematic showing the UV source 1 positioned directly above the electro-ionization device 12 with electrodes 7 and the conveyor system (all component of the system are not shown) 13 with a conveyor belt 6. The UV power unit 14 is electrically attached to the UV source. Also depicted is the electro-ionization device power unit 15.

FIG. 3 is shows an embodiment equipped with a gas injection system. The UV source 1 is disposed above the electro-ionization device 12 with electrodes 7. The electro-ionization device is powered by an AC power supply 15. Located proximal to the electrodes 7 of the electro-ionization device 12 are gas inlet jets 16 for injecting gas over the substrate surface or into the active zone. The gas inlet jets 16 are connected to a gas source (not shown) by gas supply lines 17.

Another embodiment of the invention is illustrated in FIG. 4. Ambient air, shown by arrows 25, flows from across the top of the UV source 1 which emits UV radiation, shown by squiggly lines 26, and passes though the unit to keep the UV source cooled. Most of this air is channeled out through the periphery of the bottom side of the UV source 1. This airflow enters peripheral ducting 18 and is removed via a negative pressure exhaust system 19 (exhaust fan not shown). A small amount of residual airflow is permitted to proceed to the substrate 22. This residual air and process gas, shown by dashes 27 and introduced through the inlet jets 16, along with volatilized components are captured in a duct 20 located below the substrate and removed though the ventilation system 21. The ventilation system comprises ducting and an exhaust fan (not shown), of the type used in laboratory hoods or as a gable fan. Careful balance is kept so as to not allow excess air to flow down to the substrate to restrict the flow of incoming process gas into the active zone.

FIG. 4 also shows the ducting system surrounding the periphery of the UV source 1 and the air flow dynamics. The arrows 25 depict the UV source cooling airflow direction. Air is forced downwardly over the LW source as shown. Most of the air and some of the other gaseous materials, such as contaminants, are removed through upper exhaust 19 via upper duct system 18. Remaining air and gaseous materials can be removed through the ventilation system 21 via lower ducting 20. Means for expelling excess materials from the ducting and exhaust are well known in the art. For example, exhaust fans of the type commonly used in hoods may be used.

Thus, as shown in the figures, in one embodiment, the invention provides an apparatus that comprises an electromagnetic radiation source that is stationary and that generates an active zone. The apparatus also comprises a conveyor system for conveying a substrate through the active zone whereby the substrate is exposed to the active zone for a residence time. The conveyor system may further comprise a conveyor belt for carrying the substrate. Additionally, the conveyor system may comprise a ventilation system for evacuating the active zone adjacent to the conveyor system. Further, the invention provides a method of treating a substrate by exposing the substrate to an active zone generated by a source of electromagnetic radiation. The method further comprises conveying the substrate through the active zone using a conveyor system whereby the substrate is exposed to the active zone for a residence time.

The residence time used in the method and apparatus of the invention preferably is in the range of from about 0.01 seconds to about 30 seconds, more preferably it is in the range of from about 0.1 seconds to about 10 seconds and, most preferably, it is in the range of from about 0.2 seconds to about 5 seconds.

Using the process and equipment of the invention, a polymeric substrate can be continuously, evenly and homogeneously treated using one or more gases at ambient (atmospheric) pressure. The gases include, but are not limited to, ambient air, nitrogen, oxygen, carbon dioxide, ammonia and/or various liquids that can be vaporized. These gases can be used individually or can be premixed prior to use. Gases for use in the present invention can be vaporized from the liquid form prior to entry into the gas supply line. Liquid vapor can be generated by direct heating of the liquid to an isothermal level and forcing the vapor into the gas supply lines with ambient air or any other gas desired. Alternatively, pressurized gas of any desired composition can be blown through the liquid to obtain a diluted vapor mixture of desired composition and which is then directed into the gas supply line.

The gases used in the inventive methods depend on the substrate or substrates to be treated and the material or materials being applied. As explained above, the substrate can be modified to contain functionalities that enhance the wettability of the material being applied, to the substrate, such as an adhesive. For example, if an epoxy adhesive is used, one of the preferred surface modifications should be to incorporate amine functionalities. Alternatively, if a hot melt cure adhesive, such as moisture-cured (isocyanate) hot melt, is used; in some cases, the substrate surface may be modified to include chlorine and/or oxygen functionalities, and more preferably to contain both chlorine and oxygen functionalities.

The intensity level or dosage of ultraviolet radiation is dependent on many variables such as the type of substrate to be treated, the contamination level, the type of material to be adhered to the substrate, the performance of the adhesion between the substrate and material(s) being adhered, the spectral frequencies of the ultraviolet radiation being exposed to the substrate, the level of assisted electro-ionization being applied, etc. However, the intensity of the electromagnetic radiation typically ranges from about 0.1 joules per square centimeter to about 50,000 joules per square centimeter and, more preferably, it ranges from about 2.0 joules per square centimeter to about 5,000 joules per square centimeter and, most preferably, it ranges from about 10 joules per square centimeter to about 1000 joules per square centimeter.

The frequency range of the ultraviolet radiation is also dependent on several variables. Preferably, of the electromagnetic radiation comprises radiation having a wave length in the range of about 150 nanometers to 400 nanometers and, more preferably, of the electromagnetic radiation comprises radiation having a wave length in the range of about 150 nanometers to 300 nanometers and, most preferably, of the electromagnetic radiation comprises radiation having a wave length in the range of about 150 nanometers to 250 nanometers.

The exposure times of the ultraviolet radiation depend on several variables including, but not limited to, the type of material being treated, the level of contamination, the ultraviolet dosage, the radiation frequency range, the level of assisted electro-ionization applied and the desired treatment output. However, it is preferable to have the substrate be exposed to the active zone for a time no shorter than about 0.01 seconds and no longer than about 30 seconds. It is more preferred to have the exposure time be no shorter than about 0.1 second and no longer than about 10 seconds. It is most preferable to have the exposure time be no shorter than about 0.2 sec and no longer than about 5 seconds.

Thus, in a preferred embodiment, the invention provides an apparatus for preparing a polymer substrate for adhering a material comprising an adhesive onto the polymer substrate, wherein the apparatus operates at substantially ambient pressure that comprises an electromagnetic radiation source for generating an active zone, wherein of the electromagnetic radiation is radiation having a wave length in the range of about 150 nanometers to 250 nanometers, and wherein the intensity of the electromagnetic radiation ranges from about 10 joules per square centimeter to about 1000 joules per square centimeter and wherein the electromagnetic radiation is directed to impinge on the substrate exposing a surface of the substrate to the active zone whereby the substrate is modified for adhering a material onto the surface of the substrate, and wherein the apparatus operates at substantially ambient pressure, a conveyor system for conveying the substrate through the active zone whereby the substrate is exposed to the active zone for a residence time, wherein the residence time is in the range of from about 0.2 seconds to about 5 seconds; a ventilation system whereby the active zone adjacent to the conveyor system can be evacuated; an electro-ionization device; an air supply system for circulating air past the electro-ionization device; an infra-red radiation source; and a gas injector system whereby a gas can be injected over the surface of the substrate exposed to the active zone.

The lifetimes or presence of the chemical functionalities on substrate surfaces are usually relatively short, and may range from as little as a few minutes to several days or weeks, with resulting decrease in functionalities at the top molecular level of the surface. Consequently, it may be necessary or preferred to utilize or bond a substrate treated using the inventive processes in a subsequent manufacturing process (e.g., shoe manufacturing, aircraft manufacturing, automobile manufacturing) relatively soon after it has been so treated. If this cannot be done, or if the resultant, decrease in functionalities results in the treated substrate performing below acceptable limits, several approaches may be taken. One approach to is to re-treat the substrate using the process of this invention so as to achieve similar or identical results as compared to the first treatment. An alternative approach would be to increase the amount of functionalities on the surface. However, this should be done with care as it is undesirable to include too large a number of functionalities (e.g. over-oxidation) because this tends to reduce the molecular length of the polymer chains on the substrate surface, causing loose boundary layers on the surface. Another approach would be to coat the substrate with the adhesive such as a water-based isocyanate cure system, allow it to dry, heat activate the adhesive coating and then store the part unbonded to another substrate in a clean environment. When it is desired to bond it to another substrate, at which time another coat of adhesive can be applied over the first with no additional surface preparation and proceed with bonding operations.

As noted above, one or more types of functionalities may be needed on the surface of the substrate to enhance adhesion. Preferably the surface is modified to contain from about 0.1% to about 20%, and more preferably from about 5% to about 15%, of any given chemical functionality. For example, preferably the surface is modified to contain from about 0.1% to about 20%, more preferably from about 5% to about 15% of oxygen, chlorine or amine functionalities. The above-identified percentages of functionalities are atom percentages, excluding hydrogen, as determined by electron spectroscopy for chemical analysis (ESCA). Depending on the application, it may be needed or desired to incorporate other elements and functionality groups on the polymer surface. With use of the appropriate material˜(including reactive gaseous species) it is within the skill in the art to modify the process of this invention to accomplish this.

If chlorine functionalities are desired, the active zone atmosphere can comprise carbon tetrachloride, chloroform or any other volatile material that contains chlorine. In general, halogen compounds may be used for halogen functionality. If oxygen functionalities are desired, the active zone atmosphere can contain for example, water vapor, oxygen or air. If the substrate already contains oxygen functionalities, it may be further modified to a lower oxidation state, such as from carboxyl functionality to hydroxyl functionality, using carbon dioxide gas. If amine functionalities are desired, the active zone atmosphere can contain any organic volatile composition that contains nitrogen such as ammonia or nitrogen. Other functionalities could also be added to the substrate surface in accordance with the invention.

It should be noted that polymers may contain small amounts of moisture or other compounds that may also be capable of producing the enhanced functionality by migration to the surface as the substrate is heated (for example, if enhanced oxygen functionality is desired). Thus, it may be possible to operate the process of this invention under an inert or ambient atmosphere if the substrate has sufficient water content that can migrate to or near the surface and produce the desired functionalities in the desired amount under the process operating conditions. See, for example, D. M. Brewis, Int. J. Adhesion & Adhesives, vol. 13, no. 4, p. 251, 1993.

Occasionally, there are articles that need to be treated that have complex shapes, for example where the substrates are curved and or have surfaces that are oblique to the impinging radiant flux. Because of the shapes of these articles, a reduced surface treatment may occur compared to the surfaces that are more normal to the incoming radiation. To resolve this problem, a number of approaches can be taken.

For example, one approach is to realign the photo-active zone such that the impinging treatment has an equally average exposure to all surfaces. Another approach is to have the transport system move the articles to be treated at angles such that all surfaces have an equally average exposure. Still another approach is to have more than one surface treatment unit(s) (UV light source, etc.) mounted on the same conveyor system so as to obtain an equally average exposure to all substrate surface areas.

Thus, in one embodiment the apparatus of the invention further comprises a second electromagnetic radiation source, wherein the radiation from the second electromagnetic source comprises radiation in the far ultra-violet region and wherein the radiation from the second electromagnetic source is directed to impinge on the surface of the substrate exposed to the reaction zone. Alternatively, the apparatus of the invention further comprises a plurality of electromagnetic radiation sources wherein the radiation from each of the plurality of electromagnetic sources comprises radiation in the far ultra-violet region and wherein the radiation from each of the plurality of electromagnetic sources is directed to impinge on the surface of the substrate exposed to the reaction zone. Such embodiments may be used for substrates that comprise a plurality of surfaces that lie in more than one plane, for example, a substrate that comprises a first surface and a second surface that is inclined relative to the first surface. For treating such substrates, the apparatus of the invention may also comprise means for manipulating the electromagnetic radiation to control the amount of radiation that impinges on each surface. In a preferred embodiment, the electromagnetic radiation source is moveably mounted relative to the substrate whereby in one step the electromagnetic radiation source can be moved relative to the substrate to cause the electromagnetic radiation to be incident on a first surface at an angle of about 15 degrees to about 75 degrees with respect to the normal plane of the first surface and in a second step the electromagnetic radiation source can be moved relative to the substrate to cause the electromagnetic radiation to be incident on a second surface at an angle of about 5 degrees to about 75 degrees with respect to the normal plane of the second surface.

Yet another approach is to further design the electro-ionization device such that it accommodates all surfaces equally. All of the above can be facilitated with magnetic focusing and or reflectors that can redirect the treatment to affect all substrate surface areas equally, on the average.

Also, occasionally there might be a need to treat small very complex shaped articles such as plastic thin walled 96-well microplates with only the exposure from the UV source. This can be easily accomplished by placing the article in a profiled four-sided container with a bottom (box) slightly deeper than the height of the article and made of inert materials such as a metal.

This treatment container is then filled with a reactive gas of choice and covered with a high quality quartz glass window that has a transparency from the far UV spectrum through the IR spectrum. The container is then placed on the conveyor system and passed though the photo-active zone for full continuous treatment.

By the term “polymer”, as used herein, is meant homo-polymers, co-polymers and/or their blends and alloys with other polymers and/or natural and synthetic rubbers, and polymer matrix composites, on their own, or alternatively as an integral and uppermost part of a multi-layer laminated sandwich comprising any materials e.g. polymers, metals or ceramics, synthetic or natural fibers (e.g., cotton) or an organic coating on any type of substrate material. The term “polymer” can also mean a thermoset and/or a thermoplastic material.

Particularly suitable substrates that can be modified in accordance with the invention include elastomeric substrates including vulcanized rubbers, thermoplastic substrates and thermoset plastics. Non-limiting examples of elastomeric substrates include natural rubber (MR), styrene-butyl-styrene rubber (SBS), styrene-butadiene rubber (SBR), ethylene vinyl acetate (EVA), polyurethane rubber (PU), polybutadiene rubber (BR), chlorobutyl rubber (CLLR), polyisoprene rubber (R), chloroprene rubber (CR), isobutylene-isoprene rubber (11R), ethylene-propylene-diene rubber (EPDM), silicone elastomer, acrylonitrile-butadiene rubber (NBR), polyacrylic rubber (ACM), fluoro-elastomers, and polyolefin thermoplastic elastomers. Non-limiting examples of thermoplastic substrates include polyolefins such as low density polyethylene (LDPE), polypropylene (PP), high density polyethylene (HDPE), ultra high molecular weight polyethylene (UHMWPE), blends of polyolefins with other polymers or rubbers, halogenated polymers, such as polyvinyl iden efl u o ride (PVDF), polytetra-fluoroethylene (PTFE), fluorinated ethylene-propylene copolymer (FEP), polyvinylchlorides (PVC), polystyrenes and polystyrene copolymers, po lyvi nyl acetates, acrylic thermoplastics, polyethers such as polyoxy m ethylene (Acetal), polybenzimidazoles, polybenzoxazoles, polybenzothiazoles, polyoxadiazoles, polyesters such as polyethylene terephthalate (PET), polyurethanes, polysiloxanes, polysulfides, polyacetals, polyethylenes, polyisobutylenes, silicones, polyclienes, phenolic polymers, polyacrylonitriles, polytetrafluoroethylenes, polyisoprenes, poiyjmides, polycarbonates, polyamides such as poly (h exam ethylene adipamide) (Nylon 66 ), poly(ethylene terephthalates), polyformaldehydes, methacrylate polymers such as polymethylmethacrylates (PMMA), acrylonitrile-butadiene-styrene copolymers, aromatic polymers such as polystyrene (PS) and ketone polymers such as polyetheretherketone (PEEK). Suitable thermoset plastics include, but are not limited to, epoxies, polyurethanes, cyanoacrylates, polytriazoles, polyquinoxalines, polyirn idazo pyrrol ones and copolymers containing an aromatic constituent.

Other substrates used in the shoe industry can also be modified by the methods of the invention such as, but not limited to, polyolefin thermoset elastomers such as Engage™ (homolog of polypropylene), an elastomeric foam material commercially available from Dow Plastics that contains polypropylene with a homolog-type backbone, halogenated polyolefin thermoplastic elastomers, organic fibers such as the aramid fiber, Kevlar™, and imitation and natural leathers.

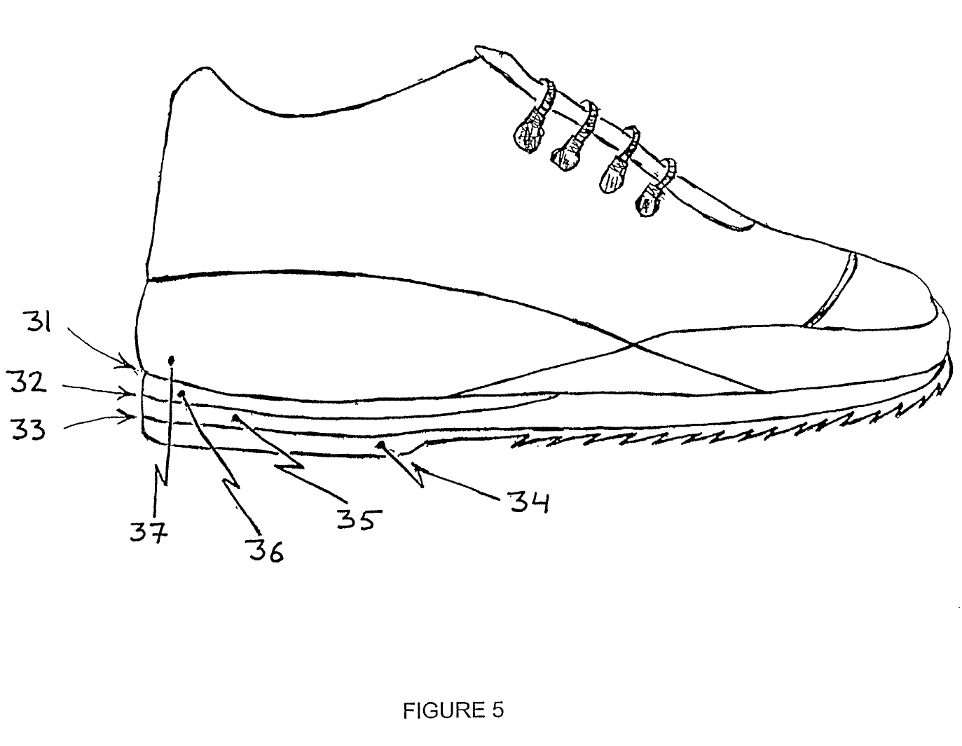

FIG. 5 illustrates a shoe according to the invention having multiple soles 34, 35 and 36. Typically, the bottom sole (outer-sole) 34 is made of a durable rubber material such as SBR. The mid-soles 35 and 36 are typically made of a foam material such as EVA or urethane foam. The upper construction 37 can be made of any suitable material such as nylon, canvas, leather and other naturally occurring polymers. Any of the sole surfaces 31, 32 or 33 can be modified in accordance with the invention. The soles can then be adhered to one another, either directly or using an adhesive. When the soles are adhered, they can be in any suitable state of matter, including both solid and liquid forms, In other words, for example, the bottom sole could be composed of a solid polyurethane elastomer and the middle sole composed of a solid foam. In that case, one or both soles could be modified and an adhesive would be used to adhere the soles, Alternatively, the bottom sole could be composed of a solid polyurethane elastomer and the middle sole could be composed of a liquid material that is capable of curing into a foam. In that case the bottom sole is modified and the middle sole is formed onto the bottom sole by pouring the liquid pre-foam material onto the bottom sole and subsequently curing the liquid pre-foam material into a solid foam mid-sole. In this embodiment, the resulting construction comprises a substantially solid foam mid-sole adhered to the bottom sole.

The substrates that have been modified using this invention can be bonded using a wide variety of adhesives and sealants. These adhesives and sealants can be in solution or dispersion with a number of solvents such as, but not limited to, water or organic-based liquids or they can be in solid form such as hot melt adhesives. Suitable adhesives include, but are not limited to, isocyanate-type polyester hot melts, isocyanate-type water-based polyurethanes, polysulfides, cyanoacrylates, epoxies, polyurethanes, polyamides, polyimides, polyimide-imides, polyamide-epichlorohydrins, polyesters, acrylic and acrylic polyesters, silicone adhesives and sealants, butacliene-acrylonitriles, butadiene-styrenes, neoprenes, butyl rubbers, polyisobutylenes, latexes, ethylenevinylacetates, epoxy-nitriles, phenolic-nitrile-phenolics, resorcinol and polyvinyl adhesives.

Suitable organosilane monomers, oligomers or polymers that may be used for coatings on substrates that have been modified using the present invention include, but are not limited to, methyltrimethoxysilane, methyltriethoxysilane, methyltrimethoxyethoxysilane, methyltriacetoxysilane, methyltripropoxysilane, methyltributoxysilane, ethyltrimethoxysi lane, ethyltriethoxysilane, gamma-meth-acryloxypropyltrimethoxysilane, gamma-aminopropyltri-methoxysilane, gamma-aminopropyltriethoxysilane, gammamercaptopropyltrimethoxysilane, chloromethyltrimethoxysilane, chloromethytriethoxysilane, dimethyidiethoxysilane, gamma-chloropropylmethyldimethoxysilane, gamma-chloropropyl-methyldiethoxysilane, tetra methoxysilane, tetraethoxysilane, tetra-n-propoxysilane, tetra-n-butoxysilane, glycid oxymethyltriethoxysilane, alpha-glycidoxyethyltrimethoxysilane, alpha-glycidoxyethyltriethoxysilane, beta-glycidoxyethyltrimethoxysilane, beta-glycidoxyethyltriethoxysilane, alpha-glycidoxy-propyltrimethoxysilane, alpha-glycidoxypropyltriethoxylilane, beta-glycidoxypropyltrimethoxysilane, beta-glycidoxypropyltriethoxysilane, gamma-glycidoxypropyltrimethoxysilane, gamma-glycidoxypropylmethyidi. methoxysilane, gamma-glycidoxy-propyldimethylethoxysilane, hydrolysates thereof, and mixtures of such silane monomers and their hydrolysates. Other potential organosilane monomers, oligomers or polymers include the organosilanes disclosed in U.S. Pat. No. 5514466, column 5, line 5 to column 7, line 12, which disclosure is incorporated herein by reference. This patent, at column 7, lines 8-12, discloses the use of organosilicone compounds containing the epoxy group and the glycidoxy group in a coating composition.

The modified substrates can also be coated effectively with protective coatings such as, but not limited to, urethanes, epoxies, latexes and the like.

This invention can be used to prepare components used in aircraft and space vehicle industry such as components made out of composite materials, and to prepare components used in automobile manufacturing, for example, plastic components and composite components.

This invention can also be used to treat polymers for bioapplications. For example, it has been shown that by using the known PCR (polymerase chain reactive) procedure it is difficult to immobilize oligonucleotides on PP polypropylene) because of the latter's extremely stable surface characteristics (non-biocompatibility, lack of wettability, etc.) (Hamaguchi et. al., Clinical Chemistry, 44: 11, Nov. 1998). However, the process of this invention provides very effective functionalization of PP and PE (polyethylene) surfaces which facilitates excellent immobilization of oligonucleotides for the capture of m-RNA (m-ribonucleic acid) and c-DNA (c-deoxyribonucleic acid) synthesis. In similar fashion, the invention also provides for functionalization of other common polymeric surfaces for the immobilization of proteins, peptides, and like compounds. Immobilization of such compounds can be useful for a variety of purposes including, for instance, immunoassays and other types of assays that take advantage of a specific affinity of an immobilized protein or other compound for a compound in solution, high throughput screening, combinatorial synthesis, etc.

### EXAMPLES

The following examples show use of the process of this invention, in various embodiments, to treat samples of typical shoe materials for subsequent bonding. The materials used include compression molded ethylene vinyl acetate (CMEVA), injection molded ethylene vinyl acetate (IMEVA), die cut ethylene vinyl acetate (DCEVA), Engage TM, styrene-butadiene rubber (SBR) and polyviny-chloride (PVC). All the substrates listed were modified by the continuous surface modification process according to the invention except for the canvas. The canvas as provided does not require any surface preparation and is used solely as a generic substrate. Canvas is extremely tough, needs no surface preparation, does not stretch, bonds extremely well and rarely fails adhesively. It therefore is used commonly as a generic substrate for purposes of testing.

Any failure that occurs will be either in one or a combination of the following: failure within the adhesive (cohesive failure), failure at the interface between the adhesive and the polymeric substrate surface (adhesive failure) or failure within the substrate (substrate failure),

In the tables below, the conveyor belt speed is given in feet per minute and the processing gas (the type of gas introduced into the reactive processing zone) flow is given in liters per minute. Atm. stands for ambient atmosphere, and Vap. stands for CHC 13 with an Atm. carrier). Test results are given in values of Kg/in (kilograms per inch). Mechanical testing was conducted on all test samples approximately 120 hours after bonding. The tests performed on all samples were 150 degree Tee Peel tension pull tests (ASTM D412-97). The pull rate was 4 inches per minute. Using this test preferably the bonded samples are able to withstand at least about 14 ppi (about 6.3 Kg/in).

Also included in many cases (as shown in the tables below) were comparative tests of the same materials prepared for bonding using standard cleaning and chlorination priming techniques currently utilized in the shoe manufacturing industry such as using 2% solution of isocyamuric acid in ethyl acetate. All the above samples were cut and bonded identically to those which had been surface treated with the continuous process surface treatment of the invention.

In Examples 1-12, substrate surfaces cut in 5 inch by 1 inch strips were treated per the conditions listed below with the continuous surface modification process of the invention. The source of electromagnetic energy was a continuous UV source emitting electromagnetic spectrum light from a mercury/xenon filled electrodeless quartz linear bulb ignited by microwave radiation. The total output was approximately 90 watts/cm 2 with approximately 30 watts/cm 2 of the total being emitted in the UV region. No attempt was made to clean the substrate surfaces; they were treated as received except for the IMEVA, which was cleaned with detergent and rinsed with water per recommendation of the supplier. The adhesive was then applied within 10 minutes of the treatment to both substrates, on the surfaces of each that had been treated, and the materials were allowed to dry in ambient air for 15 minutes. The surfaces were then heated to 170° F. and placed in contact with each other. Pressure (approx. 30 psi) was then applied to the bonded samples for approximately 1 minute. The adhesive used was a urethane water-based moisture cure adhesive system.

Table 1 describes the surface treatment process conditions and the mechanical test results for each Example 1-12.

TABLE 1
Process Conditions

| | | | | | Invention's | Standard |
|---|---|---|---|---|---|---|
| | | | Processing | | Process | Treatment |
| | | Conveyor | Gas Flow | | Test | Test |
| Example | Substrates | Belt | Rate | Processing | Results | Results |
| Numbers | Bonded | Speed | (LPM) | Gas(es) | Kg/in. | Kg/in. |
| 1 | SBR-canvas | 2 ft./min | 10 | Atm | 14.3 | 13.1 |
| 2 | SBR-IMEVA | 2-3 | 10—10 | Atm—Atm | 9.6 | 10.2 |
| | | ft./min | | | | |
| 3 | SBR-CMEV | 2-4 | 10—10 | Atm—Atm | 7.4 | 7.0 |
| | | ft./min | | | | |
| 4 | SBR/DCEV | 2-4 | 10—10 | Atm—Atm | 9.5 | 8.1 |
| | | ft./min | | | | |
| 5 | SBR/Engage ™ | 2-3 | 10-20 | Atm-Vap | 12.1 | 11.4 |
| | | ft./min | | | | |
| 6 | IMEVA/canvas | 3 ft/min | 10 | Atm | 13.0 | 12.5 |
| 7 | CMEVA/canvas | 4 ft/min | 10 | Atm | 11.1 | 10.0 |
| 8 | DCEVA/canvas | 4 ft/min | 10 | Atm | 13.9 | 12.9 |
| 9 | Engage ™/canvas | 3 ft/min | 10 | Atm | 13.6 | 10.1 |
| 10 | PVC/canvas | 3 ft/min | 10 | Atm | 18.9 | 14.5 |
| 11 | PVC | 4 ft/min | 2 | Atm | 17.9 | 16.6 |
| | foam/canvas | | | | | |
| 12 | PU foam/canvas | 5 ft/min | 3 | Atm | 12.9 | 13.6 |

As can be seen from Table 1, the bond strengths achieved using the invention's process are comparable and, in some cases, even higher than those achieved using the standard treatment process.

In Examples 13-17, the substrates were cut, treated using the process of the invention, and bonded using the water-based moisture cure adhesives as described above for Examples 1-12. However, prior to mechanical testing, they were submerged in water for 6 hours at room temperature. After exposure to this environment they were dried and mechanically tested as described above. This test (for water resistance) demonstrates the ability of the adhesive to survive in a wet environment. The results of these water-resistant tests are shown below in Table As in Table 1, Examples 1-12, comparative samples were also prepared using traditional cleaning and priming methods, and tested.

TABLE 2
Process (Water Resistance Tests)

| | | | Process | | Invention's | Standard |
|---|---|---|---|---|---|---|
| | | | Conditions | | Process | Treatment |
| | | | sing Gas | | Test | Test |
| Example | Substrates | Conveyor | Flow Rate | Processing | Results | Results |
| Numbers | Bonded | Belt Speed | (LPM) | Gas(es) | Kg/in. | Kg/in. |
| 13 | SBR-canvas | 2 ft./min | 10 | Atm | 9.6 | 8.9 |
| 14 | IMEVA-canvas | 3 ft./min | 10 | Atm | 13.3 | 13.2 |
| 15 | CMEVA- | 4 ft./min | 10 | Atm | 9.4 | 9.1 |
| | canvas | | | | | |
| 16 | DCEVA- | 4 ft./min | 10 | Atm | 15.0 | 14.5 |
| | canvas | | | | | |
| 17 | SBS/Engage ™ | 3 ft./min | 20 | Atm-vap. | 16.2 | 14.7 |

Table 2 shows that adhesive bonds created using the invention's process exhibit significant water resistance. Examples 18-25 shows tests conducted to determine the effective lifetime of the invention's process treatment. In these tests eight SBR rubber samples were surface treated using the continuous process of the invention. These samples were treated, and then cut and bonded, as in Examples 1-12, at four different times after treatment, in pairs. The first pair (Examples 18 and 19) was cut and bonded less than five minutes after treatment. The second pair (Examples 20 and 21) was cut and bonded 75 minutes after treatment. The third pair (Examples 22 and 23) was cut and bonded 150 minutes after treatment; the fourth (Examples 24 and 25) 270 minutes after treatment. All samples in this series of experiments were tested 120 hours after bonding.

TABLE 3
Continuous Surface Treatment Process Conditions (with cutting and
bonding at different time intervals after treatment)

| | | | | | Continuous | Time | |
|---|---|---|---|---|---|---|---|
| | | | | | Process | between | |
| | | | Processing | | Test | Treatment | |
| Example | Substrates | Conveyor | Gas Flow | Processing | Results | and | |
| Number | Bonded | Belt Speed | Rate (LPM) | Gas(es) | Kg/in. | Bonding | |
| 18 | SBR-canvas | 2 ft./min | 10 | Atm. | 16.2 | <5 | min. |
| 19 | SBR-canvas | 2 ft./min | 10 | Atm. | 14.8 | <5 | min. |
| 20 | SBR-canvas | 2 ft./min | 10 | Atm. | 13.7 | >5 | min. |
| 21 | SBR-canvas | 2 ft./min | 10 | Atm. | 12.2 | >5 | min. |
| 22 | SBR-canvas | 2 ft./min | 10 | Atm. | 13.5 | 150 | min. |
| 23 | SBR-canvas | 2 ft./min | 10 | Atm. | 15.1 | 150 | min. |
| 24 | SBR-canvas | 2 ft./min | 10 | Atm. | 13.7 | 270 | min. |
| 25 | SBR-canvas | 2 ft./min | 10 | Atm. | 14.6 | 270 | min. |

The data shown in Table 3 demonstrates that the effective lifetimes of the surface functionalities of the treated materials was not limited to a few minutes. To demonstrate the effectiveness of using the invention's process, namely the combination of electromagnetic energy in tandem with the controlled and regulated gas environment, in combination with the electro-ionization feature, the following comparative test was performed. A DCEVA sample was surface treated using the continuous surface treatment identically as performed in Example 8, with the difference that the conveyor belt line speed was increased to 8 feet per minute. This sample was then bonded with water-based adhesive as described above. The bonded sample was mechanically tested as described above. A second DCEVA sample was also surface treated identically to Example 26, with the difference that the electro-ionization device was used in combination with the electromagnetic radiation/reactive gas environment. Operating parameters for the electro-ionization device were 60 Hz, 12.5 kV, 60 millamperes. The sample was also bonded using the same materials and treatment as in Example 26. The results of this test are given in Table 4 below.

TABLE 4
Treatment With Electro-Ionization

| Ex- | | | | | |
|---|---|---|---|---|---|
| am- | | | | | Invention's |
| ple | | | Processing | | Process Test |
| Num- | Substrates | Conveyor | Gas Flow | Processing | Results, |
| ber | Bonded | Belt Speed | Rate (LPM) | Gas(es) | Kg/in. |
| 26 | SBR-canvas | 8 ft./min | 10 | Atm. | <0.5 |
| 27 | SBR-canvas | 8 ft./min. | 10 | Atm. | 16.4 |

Table 4 shows that for some substrates, electro-ionization greatly improves bond strengths. To demonstrate the performance of this invention's surface treatment with a hot melt adhesive, the following Examples 28-31 were performed. Substrate surfaces (DCEVA and SBR) were cut into 5 inch×1 inch samples and were surface treated using the conditions shown below in Table 5. As before, no attempt was made to pre-clean the substrate surfaces. Following the surface treatment, a hot melt (moisture cure) was applied to each treated surface. The samples were then bonded as described for the water-based adhesive in Examples 1-12 (mated, pressure was applied and allowed to set for 120 hours before testing). The results of the 150-degree mechanical peel tests are shown in Table 5 below. All samples tested had no adhesive or cohesive failure, but failure occurred within the EVA substrate.

TABLE 5
With Hot Melt Adhesive

| Ex- | | | | | |
|---|---|---|---|---|---|
| am- | | Con- | | | Invention's |
| ple | | veyor | Processing | | Process Test |
| Num- | Substrates | Belt | Gas Flow | Processing | Results, |
| bers | Bonded | Speed | Rate (LPM) | Gas(es) | Kg/in. |
| 28 | SBR-DCEVA* | 2-4 | 10-15 | CO₂—O₂ | 11.9 |
| | | ft./min | | | |
| 29 | SBR-DCEVA* | 2-4 | 10-15 | CO₂—O₂ | 12.4 |
| | | ft./min | | | |
| 30 | SBR-DCEVA* | 2-4 | 10-15 | CO₂—O₂ | 11.1 |
| | | ft./min | | | |
| 31 | SBR-DCEVA* | 2-4 | 10-15 | CO₂—O₂ | 10.9 |
| | | ft./min | | | |

All of the publications and patents which are cited in the body of the instant specification are hereby incorporated by reference in their entirety.

It is also to be appreciated that the foregoing description of the invention has been presented for purposes of illustration and explanation and is not intended to limit the invention to the precise manner of practice herein. Thus, the above descriptions of exemplary embodiments of shoes, modified substrates and methods for modifying substrates using electromagnetic energy alone or combined with electro-ionization treatment surface modification are for illustrative purposes. Because of variations that will be apparent to those skilled in the art, the present invention is not intended to be limited to the particular embodiments described above. Further, the methods of the invention can function in accordance with the practice of the invention in the absence of any of the elements or materials not specifically described herein as being part of the method. It is to be appreciated therefore, that changes may be made by those skilled in the art without departing from the spirit of the invention and that the scope of the invention should be interpreted with respect to the following claims.

What is claimed is:

1. An apparatus for preparing a substrate, the apparatus comprising:
an electromagnetic radiation source for generating an active zone, wherein said electromagnetic radiation comprises radiation in the far ultra-violet region and wherein said electromagnetic radiation is directed to impinge on the substrate exposing a surface of the substrate to the active zone whereby the substrate is modified for adhering a material onto the surface of said substrate by exposure to said active zone, and wherein the apparatus operates at substantially ambient pressure.

2. The apparatus of claim 1, wherein said electromagnetic radiation further comprises infra-red radiation.

3. The apparatus of claim 1, wherein said electromagnetic radiation comprises radiation having a wave length in the range of about 150 nanometers to about 300 nanometers.

4. The apparatus of claim 1, wherein said electromagnetic radiation comprises radiation having a wave length in the range of about 150 nanometers to about 250 nanometers.

5. The apparatus of claim 1, wherein the intensity of said electromagnetic radiation ranges from about 2.0 joules per square centimeter to about 5,000 joules per square centimeter.

6. The apparatus of claim 1, wherein the intensity of said electromagnetic radiation ranges from about 10 joules per square centimeter to about 1000 joules per square centimeter.

7. The apparatus of claim 1, wherein the electromagnetic radiation source is stationary.

8. The apparatus of claim 1, further comprising:
a conveyor system for conveying the substrate through said active zone whereby the substrate is exposed to the active zone for a residence time.

9. The apparatus of claim 8, wherein the residence time is in the range of from about 0.1 seconds to about 10 seconds.

10. The apparatus of claim 8, wherein the residence time is in the range of from about 0.2 seconds to about 5 seconds.

11. The apparatus of claim 8, wherein the conveyor system further comprises a conveyor belt for carrying the substrate.

12. The apparatus of claim 8, wherein the conveyor system further comprises a ventilation system for evacuating the active zone adjacent to the conveyor system.

13. The apparatus of claim 1 further comprising an electro-ionization device.

14. The apparatus of claim 13, wherein the electro-ionization device is located in the active zone.

15. The apparatus of claim 13 further comprising a gas supply system for circulating said gas past said electro-ionization device.

16. The apparatus of claim 1 further comprising an infra-red radiation source, wherein the substrate is heated by exposure to said infra-red radiation.

17. The apparatus of claim 16, wherein said infra-red radiation source is located to heat the substrate prior to exposure of said substrate to said electromagnetic radiation source.

18. The apparatus of claim 1 further comprising gas injectors whereby a gas can be injected over the surface of the substrate exposed to the active zone.

19. The apparatus of claim 18, wherein the gas to be injected over the surface of the substrate exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen.

20. The apparatus of claim 1 further comprising a second electromagnetic radiation source, wherein the radiation from said second electromagnetic source comprises radiation in the far ultra-violet region and wherein the radiation from said second electromagnetic source is directed to impinge on the surface of the substrate exposed to the active zone.

21. The apparatus of claim 1 further comprising a plurality of electromagnetic radiation sources wherein the radiation from each of said plurality of electromagnetic sources comprises radiation in the far ultra-violet region and wherein the radiation from each of said plurality of electromagnetic sources is directed to impinge on the surface of the substrate exposed to the active zone.

22. The apparatus of claim 1, wherein the substrate comprises a plurality of surfaces that lie in more than one plane.

23. The apparatus of claim 22 further comprising means for manipulating the electromagnetic radiation to control the amount of radiation that impinges on each surface.

24. The apparatus of claim 22, wherein the substrate comprises a first surface and a second surface that is inclined relative to the first surface.

25. The apparatus of claim 24, wherein the electromagnetic radiation source is moveably mounted relative to the substrate whereby in one step said electromagnetic radiation source can be moved relative to the substrate to cause the electromagnetic radiation to be incident on the first surface at an angle of about 15 degrees to about 75 degrees with respect to the normal plane of the first surface and in a second step said electromagnetic radiation source can be moved relative to the substrate to cause the electromagnetic radiation to be incident on the second surface at an angle of about 15 degrees to about 75 degrees with respect to the normal plane of the second surface.

26. The apparatus of claim 1, wherein the substrate is comprised of a synthetic polymer.

27. The apparatus of claim 1, wherein the substrate is comprised of a naturally-occurring polymer.

28. The apparatus of claim 1, wherein said material comprises an adhesive.

29. The apparatus of claim 1 further comprising a treatment container for holding the substrate.

30. The apparatus of claim 29, wherein the treatment container further comprises a quartz window.

31. An apparatus for preparing a substrate, the apparatus comprising:
an electromagnetic radiation source for generating an active zone, wherein said electromagnetic radiation is radiation having a wave length in the range of about 150 nanometers to about 250 nanometers, and wherein the intensity of said electromagnetic radiation ranges from about 10 joules per square centimeter to about 1000 joules per square centimeter and wherein said electromagnetic radiation is directed to impinge on the substrate exposing a surface of the substrate to the active zone whereby the substrate is modified for adhering a material onto the surface of said substrate by exposure to the active zone, and
wherein the apparatus operates at substantially ambient pressure.

32. The apparatus of claim 31, wherein said electromagnetic radiation further comprises infra-red radiation.

33. The apparatus of claim 31, wherein the electromagnetic radiation source is stationary.

34. The apparatus of claim 31, further comprising:
a conveyor system for conveying the substrate through said active zone whereby the substrate is exposed to the active zone for a residence time.

35. The apparatus of claim 34, wherein the residence time is in the range of from about 0.1 seconds to about 10 seconds.

36. The apparatus of claim 34, wherein the residence time is in the range of from about 0.2 seconds to about 5 seconds.

37. The apparatus of claim 34, wherein the conveyor system further comprises a conveyor belt for carrying the substrate.

38. The apparatus of claim 34, wherein the conveyor system further comprises a ventilation system whereby the active zone adjacent to the conveyor system can be evacuated.

39. The apparatus of claim 31 further comprising an electro-ionization device.

40. The apparatus of claim 39, wherein the electro-ionization device is located in the active zone.

41. The apparatus of claim 39 further comprising a gas supply system for circulating the gas past said electro-ionization device.

42. The apparatus of claim 34 further comprising an infra-red radiation source, wherein the substrate is heated by exposure to said infra-red radiation.

43. The apparatus of claim 42, wherein said infra-red radiation source is located to heat the substrate prior to exposure of said substrate to said electromagnetic radiation source.

44. The apparatus of claim 31 further comprising gas injectors whereby a gas can be injected over the surface of the substrate exposed to the active zone.

45. The apparatus of claim 44, wherein the gas to be injected over the surface of the substrate exposed to the active zone comprises a gas selected from the group consisting of carbon tetrachloride, chloroform, chlorine functionality compounds, oxygen functionality compounds, water vapor, oxygen, air, silanes, amine functionality compounds, ammonia, and nitrogen.

46. The apparatus of claim 31 further comprising a second electromagnetic radiation source, wherein the radiation from said second electromagnetic source comprises radiation in the far ultra-violet region and wherein the radiation from said second electromagnetic source is directed to impinge on the surface of the substrate exposed to the active zone.

47. The apparatus of claim 31 further comprising a plurality of electromagnetic radiation sources wherein the radiation from each of said plurality of electromagnetic sources comprises radiation in the far ultra-violet region and wherein the radiation from each of said plurality of electromagnetic sources is directed to impinge on the surface of the substrate exposed to the active zone.

48. The apparatus of claim 31, wherein the substrate comprises a plurality of surfaces that lie in more than one plane.

49. The apparatus of claim 48 further comprising means for manipulating the electromagnetic radiation to control the amount of radiation that impinges on each surface.

50. The apparatus of claim 48, wherein the substrate comprises a first surface and a second surface that is inclined relative to the first surface.

51. The apparatus of claim 50, wherein the electromagnetic radiation source is moveably mounted relative to the substrate whereby in one step said electromagnetic radiation source can be moved relative to the substrate to cause the electromagnetic radiation to be incident on the first surface at an angle of about 15 degrees to about 75 degrees with respect to the normal plane of the first surface and in a second step said electromagnetic radiation source can be moved relative to the substrate to cause the electromagnetic radiation to be incident on the second surface at an angle of about 15 degrees to about 75 degrees with respect to the normal plane of the second surface.

52. The apparatus of claim 31, wherein the substrate is comprised of a synthetic polymer.

53. The apparatus of claim 48, wherein the substrate is comprised of a naturally-occurring polymer.

54. The apparatus of claim 48, wherein said material comprises an adhesive.

55. The apparatus of claim 48 further comprising a treatment container for holding the substrate.

56. The apparatus of claim 55, wherein the treatment container further comprises a quartz window.

57. An apparatus for preparing a polymer substrate for adhering a material comprising an adhesive onto said polymer substrate, wherein the apparatus operates at substantially ambient pressure, the apparatus comprising:
an electromagnetic radiation source for generating an active zone, wherein said electromagnetic radiation is radiation having a wave length in the range of about 150 nanometers to 250 nanometers, and wherein the intensity of said electromagnetic radiation ranges from about 10 joules per square centimeter to about 1000 joules per square centimeter and wherein said electromagnetic radiation is directed to impinge on the substrate exposing a surface of the substrate to the active zone whereby the substrate is modified for adhering a material onto the surface of said substrate by exposure to the active zone, and
wherein the apparatus operates at substantially ambient pressure a conveyor system for conveying the substrate through said active zone whereby the substrate is exposed to the active zone for a residence time, wherein the residence time is in the range of from about 0.2 seconds to about 5 seconds;
a ventilation system whereby the active zone adjacent to the conveyor system can be evacuated;
an electro-ionization device;
an air supply system for circulating air past said electro-ionization device;
an infra-red radiation source; and
a gas injector system whereby a gas can be injected over the surface of the substrate exposed to the active zone.

58. The apparatus of claim 57, wherein said infra-red radiation source is located to heat the substrate prior to exposure of said substrate to said electromagnetic radiation source.

59. The apparatus of claim 57, wherein the gas to be injected over the surface of the substrate exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen.

60. The apparatus of claim 57, further comprising a second electromagnetic radiation source, wherein the radiation from said second electromagnetic source comprises radiation in the far ultra-violet region and wherein the radiation from said second electromagnetic source is directed to impinge on the surface of the substrate exposed to the active zone.

61. The apparatus of claim 57, further comprising a plurality of electromagnetic radiation sources wherein the radiation from each of said plurality of electromagnetic sources comprises radiation in the far ultra-violet region and wherein the radiation from each of said plurality of electromagnetic sources is directed to impinge on the surface of the substrate exposed to the active zone.

62. The apparatus of claim 57, wherein the substrate comprises a plurality of surfaces that lie in more than one plane.

63. The apparatus of claim 62 further comprising means for manipulating the electromagnetic radiation source to control the amount of radiation that impinges on each surface.

64. The apparatus of claim 62, wherein the substrate comprises a first surface and a second surface that is inclined relative to the first surface.

65. The apparatus of claim 64, wherein the electromagnetic radiation source is moveably mounted relative to the substrate whereby in one step said electromagnetic radiation source can be moved relative to the substrate to cause the electromagnetic radiation to be incident on the first surface at an angle of about 15 degrees to about 75 degrees with respect to the normal plane of the first surface and in a second step said electromagnetic radiation source can be moved relative to the substrate to cause the electromagnetic radiation to be incident on the second surface at an angle of about 15 degrees to about 75 degrees with respect to the normal plane of the second surface.

66. The apparatus of claim 57, wherein the substrate is comprised of a synthetic polymer.

67. The apparatus of claim 57, wherein the substrate is comprised of a naturally-occurring polymer.

68. An apparatus for fabricating a shoe having at least one sole, the apparatus comprising:
an electromagnetic radiation source for generating an active zone, wherein said electromagnetic radiation comprises radiation in the far ultra-violet region and wherein said electromagnetic radiation is directed to impinge on the sole exposing a surface of the sole to the active zone whereby the sole is modified for adhering a material onto the surface of said sole, and
wherein the apparatus operates at substantially ambient pressure.

69. The apparatus of claim 68, wherein said electromagnetic radiation further comprises infra-red radiation.

70. The apparatus of claim 68, wherein of said electromagnetic radiation comprises radiation having a wave length in the range of about 150 nanometers to 300 nanometers.

71. The apparatus of claim 68, wherein of said electromagnetic radiation comprises radiation having a wave length in the range of about 150 nanometers to 250 nanometers.

72. The apparatus of claim 68, wherein the intensity of said electromagnetic radiation ranges from about 2.0 joules per square centimeter to about 5,000 joules per square centimeter.

73. The apparatus of claim 68, wherein the intensity of said electromagnetic radiation ranges from about 10 joules per square centimeter to about 1000 joules per square centimeter.

74. The apparatus of claim 68, wherein the electromagnetic radiation source is stationary.

75. The apparatus of claim 68, further comprising:
a conveyor system for conveying the substrate through said active zone whereby the substrate is exposed to the active zone for a residence time.

76. The apparatus of claim 75, wherein the residence time is in the range of from about 0.1 seconds to about 10 seconds.

77. The apparatus of claim 75, wherein the residence time is in the range of from about 0.2 seconds to about 5 seconds.

78. The apparatus of claim 75, wherein the conveyor system further comprises a conveyor belt for carrying the sole.

79. The apparatus of claim 75, wherein the conveyor system further comprises a ventilation system for evacuating the active zone adjacent to the conveyor system.

80. The apparatus of claim 68 further comprising an electro-ionization device.

81. The apparatus of claim 80, wherein the electro-ionization device is located in the active zone.

82. The apparatus of claim 80 further comprising an air supply system for circulating air past said electro-ionization device.

83. The apparatus of claim 68 further comprising an infra-red radiation source, wherein the sole is heated by exposure to said infra-red radiation.

84. The apparatus of claim 83, wherein said infra-red radiation source is located to heat the sole prior to exposure of said sole to said electromagnetic radiation source.

85. The apparatus of claim 68 further comprising gas injectors whereby a gas can be injected over the surface of the sole exposed to the active zone.

86. The apparatus of claim 85, wherein the gas to be injected over the surface of the sole exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen.

87. The apparatus of claim 68 further comprising a second electromagnetic radiation source, wherein the radiation from said second electromagnetic source comprises radiation in the far ultra-violet region and wherein the radiation from said second electromagnetic source is directed to impinge on the surface of the sole exposed to the active zone.

88. The apparatus of claim 68 further comprising a plurality of electromagnetic radiation sources wherein the radiation from each of said plurality of electromagnetic sources comprises radiation in the far ultra-violet region and wherein the radiation from each of said plurality of electromagnetic sources is directed to impinge on the surface of the sole exposed to the active zone.

89. The apparatus of claim 68, wherein the sole is comprised of a synthetic polymer.

90. The apparatus of claim 68, wherein the sole is comprised of a naturally-occurring polymer.

91. The apparatus of claim 68, wherein said material comprises an adhesive.

92. A method for preparing a substrate, the method comprising:
generating an active zone using an electromagnetic radiation source; and
exposing said substrate to the active zone whereby the substrate is modified for adhering a material comprising an adhesive onto said substrate by exposure to the active zone, and
wherein the method is performed at substantially ambient pressure.

93. The method of claim 92, wherein the substrate comprises a polymer.

94. The method of claim 92, wherein said substrate comprises a sole of a shoe.

95. The method of claim 92, wherein said substrate comprises a composite used in aircraft and space vehicle fabrication.

96. The method of claim 92, wherein said substrate comprises a component used in automobile manufacturing.

97. The method of claim 92, wherein said substrate comprises a well-plate, wherein said well-plate is used for biochemical analysis.

98. The method of claim 92, wherein said electromagnetic radiation further comprises infra-red radiation.

99. The method of claim 92, wherein of said electromagnetic radiation comprises radiation having a wave length in the range of about 150 nanometers to 300 nanometers.

100. The method of claim 92, wherein of said electromagnetic radiation comprises radiation having a wave length in the range of about 150 nanometers to 250 nanometers.

101. The method of claim 92, wherein the intensity of said electromagnetic radiation ranges from about 2.0 joules per square centimeter to about 5,000 joules per square centimeter.

102. The method of claim 92, wherein the intensity of said electromagnetic radiation ranges from about 10 joules per square centimeter to about 1000 joules per square centimeter.

103. The method of claim 92, further comprising: conveying the substrate through said active zone using a conveyor system whereby the substrate is exposed to the active zone for a residence time.

104. The method of claim 103, wherein the residence time is in the range of from about 0.1 seconds to about 10 seconds.

105. The method of claim 103, wherein the residence time is in the range of from about 0.2 seconds to about 5 seconds.

106. The method of claim 103, wherein the conveyor system further comprises a conveyor belt for carrying the substrate.

107. The method of claim 103, further comprising:
evacuating the active zone adjacent to the conveyor system.

108. The method of claim 92 further comprising:
exposing the substrate to a discharge from an electro-ionization device.

109. The method of claim 108, wherein the electro-ionization device is located in the active zone.

110. The method of claim 108 further comprising:
circulating a gas past said electro-ionization device so that said gas flows over the electro-ionization device onto the substrate.

111. The method of claim 103 further comprising:
exposing the substrate to an infra-red radiation source, wherein the substrate is heated by exposure to said infra-red radiation.

112. The method of claim 111, wherein the step of exposing the substrate to said infra-red radiation source is performed prior to the step of exposing said substrate to the active zone.

113. The method of claim 92, further comprising:
injecting a gas over the surface of the substrate exposed to the active zone.

114. The method of claim 113, wherein the gas to be injected over the surface of the substrate exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen.

115. A method for preparing a polymer substrate, the method comprising:
generating an active zone at substantially atmospheric pressure using an electromagnetic radiation source, wherein said electromagnetic radiation is radiation having a wave length in the range of about 150 nanometers to 250 nanometers, and wherein the intensity of said electromagnetic radiation ranges from about 10 joules per square centimeter to about 1000 joules per square centimeter whereby the polymer substrate is modified for adhering a material comprising an adhesive onto said polymer substrate by exposure to said active zone; p1 conveying the substrate through said active zone whereby the substrate is exposed to the active zone for a residence time, wherein the residence time is in the range of from about 0.2 seconds to about 5 seconds;
evacuating the active zone adjacent to the conveyor system;
exposing the surface to an electro-ionization device;
circulating a first gas stream past said electro-ionization device so that the first gas stream flows past the electro-ionization device and onto the surface;
exposing the surface to an infra-red radiation source; and injecting a second gas stream over the surface of the substrate.

116. The method of claim 115, wherein the step of exposing the substrate to said infra-red radiation source is performed prior to the step of exposing said substrate to the active zone.

117. The method of claim 115, wherein the gas of the first gas stream to be injected over the surface of the substrate exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen.

118. The method of claim 115, wherein the gas of the second gas stream to be injected over the surface of the substrate exposed to the active zone comprises a gas selected from the group consisting of carbon tetrachloride, chloroform, halogen functionality compounds, oxygen functionality compounds, water vapor, oxygen, air, silanes, amine functionality compounds, ammonia, and nitrogen.

119. The method of claim 115, wherein the substrate is comprised of a synthetic polymer.

120. The method of claim 115, wherein the substrate is comprised of a naturally-occurring polymer.
